(19) United States
(12) Patent Application Publication
(10) Pub. No.: US 2018/0081208 A1
(43) Pub. Date: Mar. 22, 2018

(54) LIQUID CRYSTAL DISPLAY AND ELECTRONIC EQUIPMENT

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Wenqing ZHAO, Beijing (CN); Xue DONG, Beijing (CN); Xiaochuan CHEN, Beijing (CN); Qian WANG, Beijing (CN)

(21) Appl. No.: 15/540,810

(22) PCT Filed: May 27, 2016
(86) PCT No.: PCT/CN2016/083625

§ 371 Date: Jun. 29, 2017

(30) Foreign Application Priority Data
Mar. 3, 2016 (CN) 201610121289.1

(51) Int. Cl. G02F 1/137; G02F 1/1343; G02F 1/1335; G02F 1/13; G09G 3/36; G06F 3/01

(52) U.S. Cl. CPC G02F 1/137; G02F 1/134309; G02F 1/133528; G02F 1/1336; G02F 2203/30; G02F 1/1323; G09G 3/3696; G06F 3/013; G02F 2001/133531; G02F 1/13439

(57) ABSTRACT

A liquid crystal display and electronic equipment are provided. During displaying, the control unit applies a voltage between the sub-electrodes and the first transparent electrode based on an image data, so that liquid crystal molecules in the liquid crystal layer corresponding to the electrode unit are deflected to form a microprism structure. The microprism structure is adjusted by controlling the magnitude of the potential on the sub-electrodes of the electrode unit, thereby controlling a ratio of energy distribution within a preset viewing angle range for light emitted from the backlight and refracted by the microprism structure. Therefore, the light intensity within the preset viewing angle range can be controlled by the microprism structure, realizing gray scale display.

### RELATED APPLICATIONS

The present application is the U.S. national phase entry of the international application PCT/CN2016/083625, with an international filing date of May 27, 2016, which claims the benefit of Chinese Patent Application No. 201610121289.1, filed on Mar. 3, 2016, the entire disclosures of which are incorporated herein by reference.

### TECHNICAL FIELD

The present disclosure relates to the field of display technology, in particular to a liquid crystal display and electronic equipment.

### BACKGROUND

An existing liquid crystal display panel typically includes an array substrate and a color film substrate disposed oppositely, a liquid crystal layer located between the array substrate and the color film substrate, a common electrode, a pixel electrode, and polarizers respectively located on the array substrate and the color film substrate.

The existing liquid crystal display panel converts natural light into linearly polarized light through the polarizer on the array substrate. A voltage is applied between the pixel electrode and the common electrode to form an electric field in the liquid crystal layer. The liquid crystal molecules in the liquid crystal layer are rotated by the electric field, so as to change the polarization state of the linearly polarized light. The polarizer on the color film substrate then analyzes the polarization state of the linearly polarized light. By controlling the magnitude of the electric field the polarization state can be adjusted. Different polarization states mean different light transmittance of the liquid crystal display panel, thereby achieving gray scale display for images.

### SUMMARY

An embodiment of the disclosure provides a liquid crystal display to achieve gray scale display within a preset viewing angle range.

The liquid crystal display provided by the embodiment of the disclosure includes a backlight, a lower substrate on a light exit side of the backlight, an upper substrate arranged opposite to the lower substrate, and a liquid crystal layer located between the upper substrate and the lower substrate. The liquid crystal display further includes a first transparent electrode and a second transparent electrode respectively located on both sides of the liquid crystal layer, and a control unit for applying a voltage between the first transparent electrode and the second transparent electrode. The first transparent electrode is a planar electrode. The second transparent electrode includes a plurality of electrode units, and each electrode unit includes a plurality of sub-electrodes arranged in parallel and extending in a straight line.

During displaying, the control unit applies a voltage between the sub-electrodes and the first transparent electrode based on an image data, so that liquid crystal molecules in the liquid crystal layer corresponding to the electrode unit are deflected to form a microprism structure. The microprism structure is adjusted by controlling the magnitude of the potential on the sub-electrodes of the electrode unit, thereby controlling a ratio of energy distribution within a preset viewing angle range for light emitted from the backlight and refracted by the microprism structure.

In certain exemplary embodiments of the liquid crystal display, the first transparent electrode and the second transparent electrode are located between the upper substrate and the lower substrate.

In certain exemplary embodiments of the liquid crystal display, the liquid crystal display further includes a color conversion layer located on a side of the liquid crystal layer departing from the lower substrate. The color conversion layer is used for converting light passing through the liquid crystal layer corresponding to the microprism structure into light of at least one color, and light emitted from the backlight is converted into light of at least three colors after passing through the color conversion layer.

In certain exemplary embodiments of the liquid crystal display, the color conversion layer is a light splitting film or a color filter film.

In certain exemplary embodiments of the liquid crystal display, light emitted from the backlight is collimated light or parallel light.

In certain exemplary embodiments of the liquid crystal display, the liquid crystal display further includes a human eye tracking unit. The human eye tracking unit determines the preset viewing angle range by tracking a target human eye and transmits the determined preset viewing angle range to the control unit. The control unit adjusts the voltage applied on the sub-electrodes of the electrode unit based on the preset viewing angle range.

In certain exemplary embodiments of the liquid crystal display, the first transparent electrode is located on a side of the upper substrate facing the liquid crystal layer, and the second transparent electrode is located on a side of the lower substrate facing the liquid crystal layer. Alternatively, the second transparent electrode is located on a side of the upper substrate facing the liquid crystal layer, and the first transparent electrode is located on a side of the lower substrate facing the liquid crystal layer.

In certain exemplary embodiments of the liquid crystal display, the greater an equivalent optical path of the microprism structure along a cell thickness of the liquid crystal display, the smaller a voltage difference applied on the transparent electrodes on both sides of the liquid crystal layer corresponding to the microprism structure.

In certain exemplary embodiments of the liquid crystal display, the microprism structure is a triangular prism structure and/or a quadrilateral prism structure.

In certain exemplary embodiments of the liquid crystal display, the sub-electrode is composed of at least one linear electrode or a plurality of punctate electrodes.

In certain exemplary embodiments of the liquid crystal display, the liquid crystal display further includes a first polarizer located between the lower substrate and the backlight.

In certain exemplary embodiments of the liquid crystal display, the liquid crystal display further includes a second polarizer located on a side of the upper substrate departing from the liquid crystal layer. A polarization direction of the second polarizer is parallel to a polarization direction of the first polarizer.

An embodiment of the disclosure further provides electronic equipment. The electronic equipment includes the liquid crystal display according to the above mentioned embodiments.

The embodiments of the present disclosure provide a liquid crystal display and electronic equipment. During displaying, the control unit applies a voltage between the sub-electrodes and the first transparent electrode based on an image data, so that liquid crystal molecules in the liquid crystal layer corresponding to the electrode unit are deflected to form a microprism structure. The microprism structure is adjusted by controlling the magnitude of the potential on the sub-electrodes of the electrode unit, thereby controlling a ratio of energy distribution within a preset viewing angle range for light emitted from the backlight and refracted by the microprism structure. Therefore, the light intensity within the preset viewing angle range can be controlled by the microprism structure, realizing gray scale display.

### BRIEF DESCRIPTION OF THE DRAWINGS

FIG. 1a and FIG. 1b are respectively structural schematic diagrams of liquid crystal displays according to some embodiments of the disclosure;

FIG. 2a to FIG. 2d are respectively schematic diagrams of microprism structures realizing gray scale display in a liquid crystal display according to an embodiment of the disclosure;

FIG. 3a to FIG. 3d are respectively schematic diagrams of microprism structures realizing gray scale display in a liquid crystal display according to an embodiment of the disclosure;

FIG. 4a to FIG. 4g are respectively schematic diagrams of microprism structures realizing gray scale display in a liquid crystal display according to an embodiment of the disclosure;

FIG. 5 is a schematic diagram showing the relation between a microprism structure in a liquid crystal display and a voltage applied on corresponding sub-electrodes according to an embodiment of the disclosure;

FIG. 6a to FIG. 6d are respectively structural schematic diagrams of sub-electrodes according to an embodiment of the disclosure;

FIG. 7a and FIG. 7b are respectively structural schematic diagrams of liquid crystal displays according to some embodiments of the disclosure; and

FIG. 8a and FIG. 8b are respectively structural schematic diagrams of liquid crystal displays according to some embodiments of the disclosure.

### DETAILED DESCRIPTION OF THE DISCLOSURE

In the following, the technical solutions in the embodiments of the invention will be described clearly and completely in connection with the drawings in the embodiments of the invention. Obviously, the described embodiments are only part of the embodiments of the invention, and not all of the embodiments. Based on the embodiments in the invention, all other embodiments obtained by those of ordinary skills in the art under the premise of not paying out creative work pertain to the protection scope of the invention.

The shapes and sizes of the elements in the drawings do not reflect the real scale of the film layers, but to schematically illustrate the content of the disclosure.

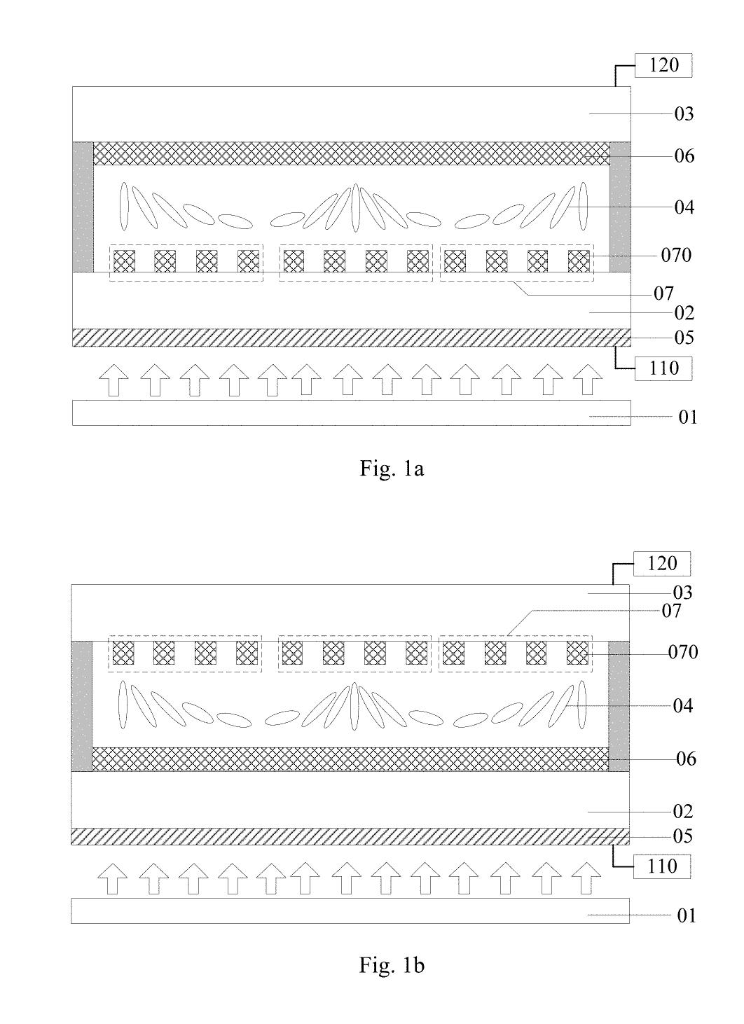

As shown in FIG. 1a and FIG. 1b, the liquid crystal display provided by the embodiment of the disclosure includes a backlight 01, a lower substrate 02 on a light exit side of the backlight 01, an upper substrate 03 arranged opposite to the lower substrate 02, and a liquid crystal layer 04 located between the upper substrate 03 and the lower substrate 02. The liquid crystal display further includes a first transparent electrode 06 and a second transparent electrode respectively located on both sides of the liquid crystal layer 04, and a control unit 110 for applying a voltage between the first transparent electrode 06 and the second transparent electrode. The first transparent electrode 06 is a planar electrode. The second transparent electrode includes a plurality of electrode units 07, and each electrode unit 07 includes a plurality of sub-electrodes 070 arranged in parallel and extending in a straight line.

During displaying, the control unit 110 applies a voltage between the sub-electrodes 070 and the first transparent electrode 06 based on an image data, so that liquid crystal molecules in the liquid crystal layer 04 corresponding to the electrode unit 07 are deflected to form a microprism structure. The microprism structure is adjusted by controlling the magnitude of the potential on the sub-electrodes 070 of the electrode unit 07, thereby controlling a ratio of energy distribution within a preset viewing angle range for light emitted from the backlight 01 and refracted by the microprism structure.

In the liquid crystal display provided by the embodiment of the present disclosure, during displaying, the control unit applies a voltage between the sub-electrodes and the first transparent electrode based on an image data, so that liquid crystal molecules in the liquid crystal layer corresponding to the electrode unit are deflected to form a microprism structure. The microprism structure is adjusted by controlling the magnitude of the potential on the sub-electrodes of the electrode unit, thereby controlling a ratio of energy distribution within a preset viewing angle range for light emitted from the backlight and refracted by the microprism structure. Therefore, the light intensity within the preset viewing angle range can be controlled by the microprism structure, realizing gray scale display.

It should be noted that, in the liquid crystal display provided by the embodiment of the present disclosure, the ratio of energy distribution within a preset viewing angle range refers to a ratio between the energy of light refracted by a microprism structure within the preset viewing angle range and all the energy of light refracted by the microprism structure.

In an implementation, in the liquid crystal display provided by the embodiment of the present disclosure, as shown in FIG. 1a, the first transparent electrode 06 is located on a side of the upper substrate 03 facing the liquid crystal layer 04, and the second transparent electrode (including the electrode units 07 in the drawing) is located on a side of the lower substrate 02 facing the liquid crystal layer 04. Alternatively, as shown in FIG. 1b, the second transparent electrode (including the electrode units 07 in the drawing) is located on a side of the upper substrate 03 facing the liquid crystal layer 04, and the first transparent electrode 06 is located on a side of the lower substrate 02 facing the liquid crystal layer 04.

In certain exemplary embodiments, the first transparent electrode 06 and the second transparent electrode are located between the upper substrate 03 and the lower substrate 02. With such an arrangement, the liquid crystal molecules in the liquid crystal layer 04 can be more accurately controlled.

The principles of the present disclosure will now be described in detail with reference to some embodiments. It should be noted that the embodiments aim to provide a better explanation for the present disclosure, and the present disclosure is not limited thereto.

In certain exemplary embodiments of the liquid crystal display, the microprism structure is a triangular prism structure and/or a quadrilateral prism structure.

In particular, some microprism structures are taken as examples, in which the microprism structures are respectively located on the left/right side of or facing the target human. The principle of gray scale display is illustrated, in which a ratio of energy distribution within a preset viewing angle range for light refracted by the microprism structure can be adjusted by controlling the microprism structure.

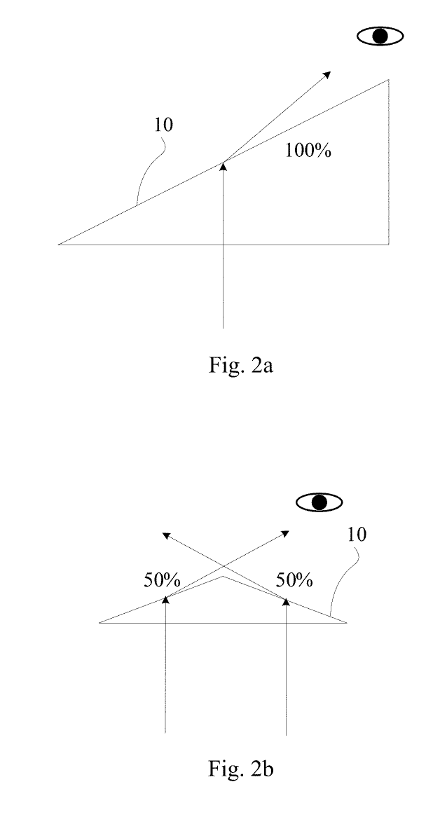

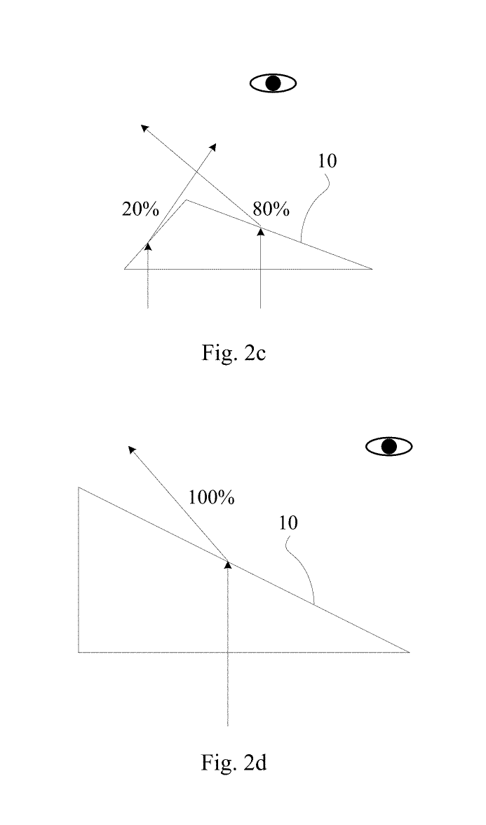

Specifically, as shown in FIG. 2a to FIG. 2d, if the target human eye is on the right side of the microprism structure 10, the light beam refracted to the right side by the microprism structure 10 enters the target human eye. As shown in FIG. 2a, if the microprism structure 10 is a right triangular prism and the hypotenuse of the right triangular prism departs from the target human eye, the light beam refracted by the microprism structure 10 is directed toward the target human eye. That is, the ratio of energy distribution of the outgoing light entering the target human eye is 100%, so that a high gray scale display can be realized. As shown in FIG. 2b, if the microprism structure 10 is an isosceles triangular prism, half of the light beam refracted by the microprism structure 10 is directed toward the target human eye. That is, the ratio of energy distribution of the outgoing light entering the target human eye is 50%, so that a medium gray scale display can be realized. As shown in FIG. 2c, if the microprism structure 10 is an ordinary triangular prism and the shortest side of the ordinary triangular prism departs from the target human eye side, a small portion of the light refracted by the microprism structure 10 is directed toward the target human eye. Assuming that the ratio of energy distribution of the outgoing light entering the target human eye is 20%, a low gray scale display can thus be achieved. As shown in FIG. 2d, if the microprism structure 10 is a right triangular prism and the hypotenuse of the right triangular prism faces the target human eye, no light is directed toward the target human eye, so that a low gray scale display can be achieved.

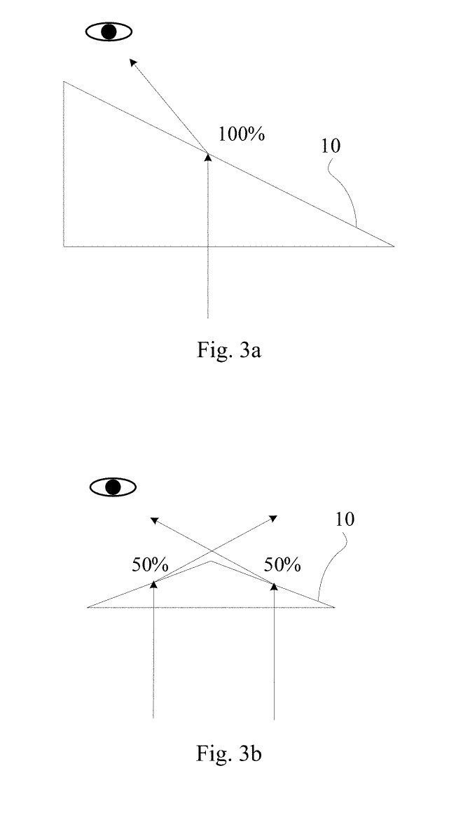

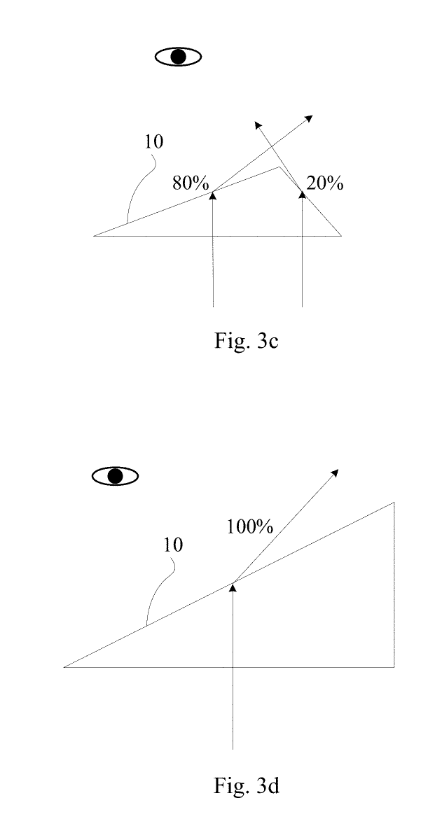

Specifically, as shown in FIG. 3a to FIG. 3d, if the target human eye is on the left side of the microprism structure 10, the light beam refracted to the left side by the microprism structure 10 enters the target human eye. As shown in FIG. 3a, if the microprism structure 10 is a right triangular prism and the hypotenuse of the right triangular prism departs from the target human eye, the light beam refracted by the microprism structure 10 is directed toward the target human eye. That is, the ratio of energy distribution of the outgoing light entering the target human eye is 100%, so that a high gray scale display can be realized. As shown in FIG. 3b, if the microprism structure 10 is an isosceles triangular prism, half of the light beam refracted by the microprism structure 10 is directed toward the target human eye. That is, the ratio of energy distribution of the outgoing light entering the target human eye is 50%, so that a medium gray scale display can be realized. As shown in FIG. 3c, if the microprism structure 10 is an ordinary triangular prism and the shortest side of the ordinary triangular prism departs from the target human eye side, a small portion of the light refracted by the microprism structure 10 is directed toward the target human eye. Assuming that the ratio of energy distribution of the outgoing light entering the target human eye is 20%, a low gray scale display can thus be achieved. As shown in FIG 3d, if the microprism structure 10 is a right triangular prism and the hypotenuse of the right triangular prism faces the target human eye, no light is directed toward the target human eye, so that a low gray scale display can be achieved.

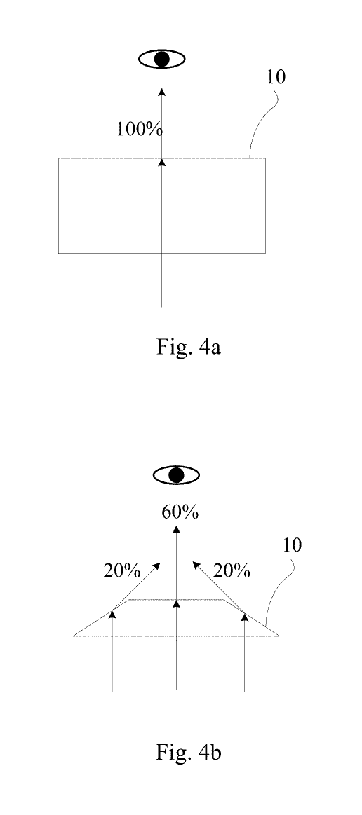

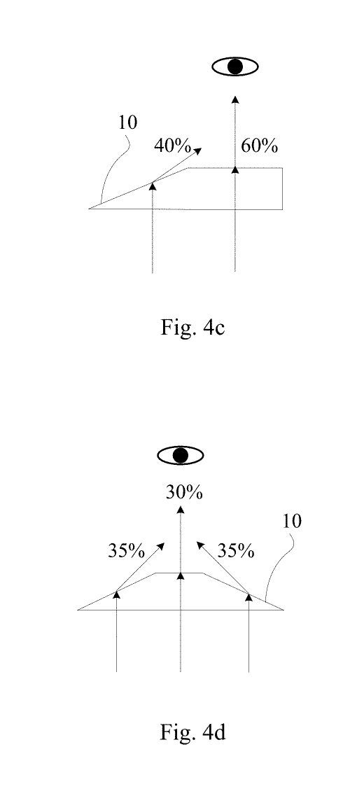

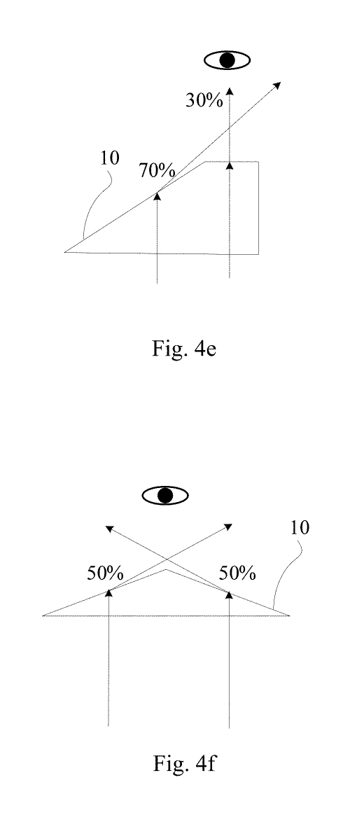

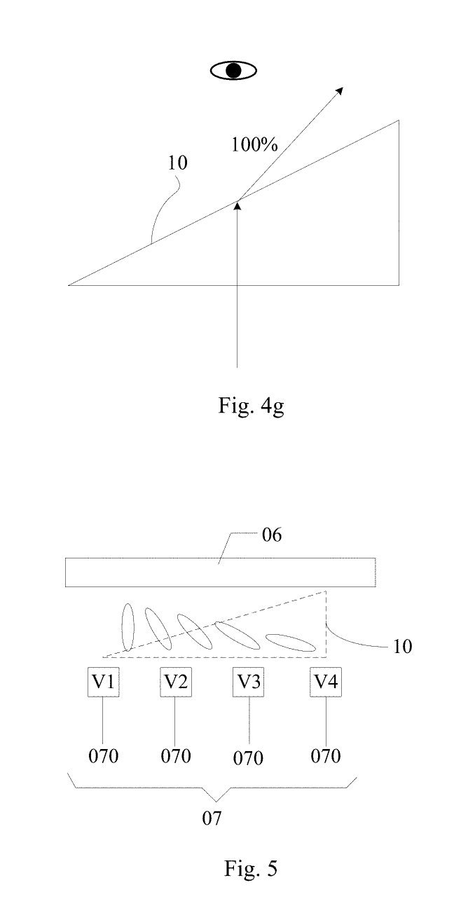

In particular, as shown in FIG. 4a to FIG. 4g, if the target human eye faces the microprism structure 10, the light beam refracted forward by the microprism structure 10 enters the target human eye. As shown in FIG. 4a, if the microprism structure 10 is a rectangular prism, the light beam refracted by the microprism structure 10 is directed toward the target human eye. That is, the ratio of energy distribution of the outgoing light entering the target human eye is 100%, so that a high gray scale display can be achieved. As shown in FIG. 4b to FIG. 4e, if the microprism structure 10 is a trapezoidal prism and a relatively shorter base of the trapezoidal prism is near the target human eye, a portion of the light refracted by the microprism structure 10 is directed toward the target human eye, so that a medium gray scale display can be achieved. Specifically, the ratio of the energy entering the target human eye can be adjusted by adjusting the lengths of the two bases of the trapezoidal prism. It is assumed that the ratio of energy distribution of the outgoing light entering the target human eye in FIG. 4b and FIG. 4c is 60%, the ratio of energy distribution of the outgoing light entering the target human eye in FIG. 4d and FIG. 4e is 30%. As shown in FIG. 4f and FIG. 4g, if the microprism structure 10 is a triangular prism, no light is directed in front of the microprism structure 10. That is, no light is directed toward the target human eye, so that a low gray scale display can be achieved.

The principle of gray scale display has been illustrated in the above mentioned examples, in which gray scale display can be achieved by controlling a ratio of energy distribution within a preset viewing angle range for light refracted by the microprism structure. The specific microprism structure can also be other structures which enable the implementation of the embodiment of the present disclosure. The microprism structure can be adjusted by controlling the size of the first transparent electrode and the sub-electrodes based on the image data, which is not limited herein. In addition, the eyes in FIGS. 2a to 4g are intended only to illustrate the direction of the target human eye, and one eye can correspond to a plurality of microprism structures.

Further, in an implementation, in the liquid crystal display provided by the embodiment of the disclosure, the greater an equivalent optical path of the microprism structure along a cell thickness of the liquid crystal display, the smaller a voltage difference applied on the transparent electrodes on both sides of the liquid crystal layer corresponding to the microprism structure. As shown in FIG. 5, for example, the microprism structure is a right triangular prism. Assuming that one electrode unit 07 includes four parallel-arranged sub-electrodes 070 and the sub-electrodes 070 are linear, the potential applied on these four sub-electrodes 070 in FIG. 5 are respectively V1, V2, V3 and V4, and V1>V2>V3>V4. From left to right, the equivalent optical path of the microprism structure 10 is getting greater and greater.

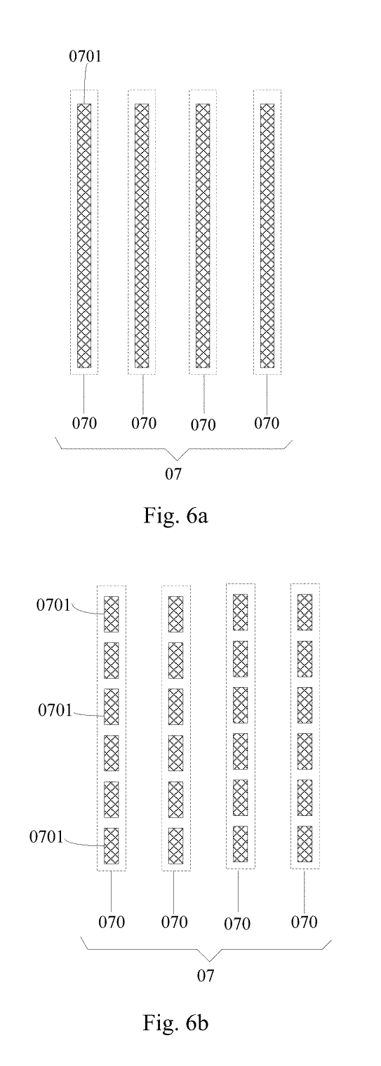

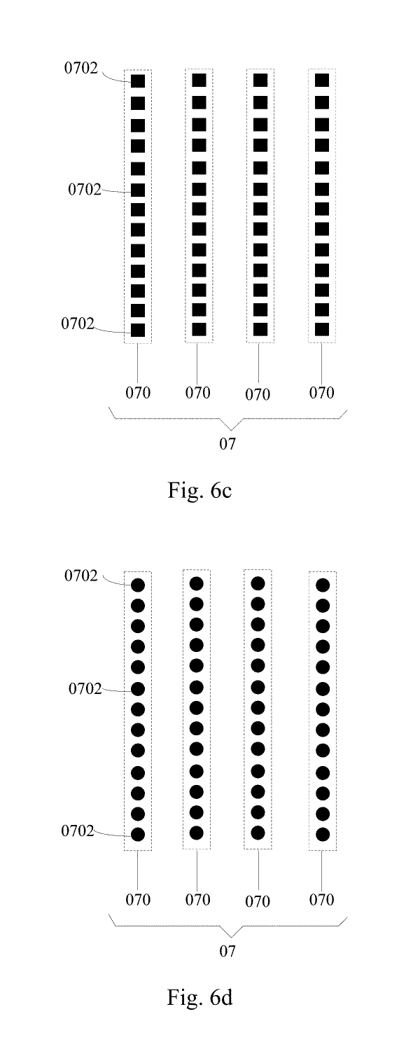

In certain exemplary embodiments of the liquid crystal display, as shown in FIG. 6a and FIG. 6b, the sub-electrode 070 is composed of at least one linear electrode 0701.

Alternatively, in certain exemplary embodiments of the liquid crystal display, as shown in FIG. 6c and FIG. 6d, the sub-electrode 070 is composed of a plurality of punctate electrodes 0702. In some implementations, the shape of the punctate electrode can be a point having a regular shape, such as a dot, a square point. Of course, it can also be an irregularly shaped point, which is not limited herein.

In the liquid crystal display provided by the embodiment of the disclosure, the gray scale is adjusted by controlling a ratio of energy distribution within a preset viewing angle range for light refracted by the microprism structure. Light emitted from the backlight is typically circularly polarized light, therefore, a first polarizer 05 can be arranged on the lower substrate to convert light emitted from the backlight into linearly polarized light. The ratio of energy distribution of the outgoing light within a preset viewing angle range can be precisely adjusted by controlling the microprism structure.

Further, in an implementation, it should be ensured that the incident directions of the light beams emitted from the backlight toward the display panel with the liquid crystal prisms are the same, so that the ratio of energy distribution of the outgoing light within a preset viewing angle range can be precisely adjusted by controlling the microprism structure. Therefore, in certain exemplary embodiments of the liquid crystal display, light emitted from the backlight is collimated light or parallel light.

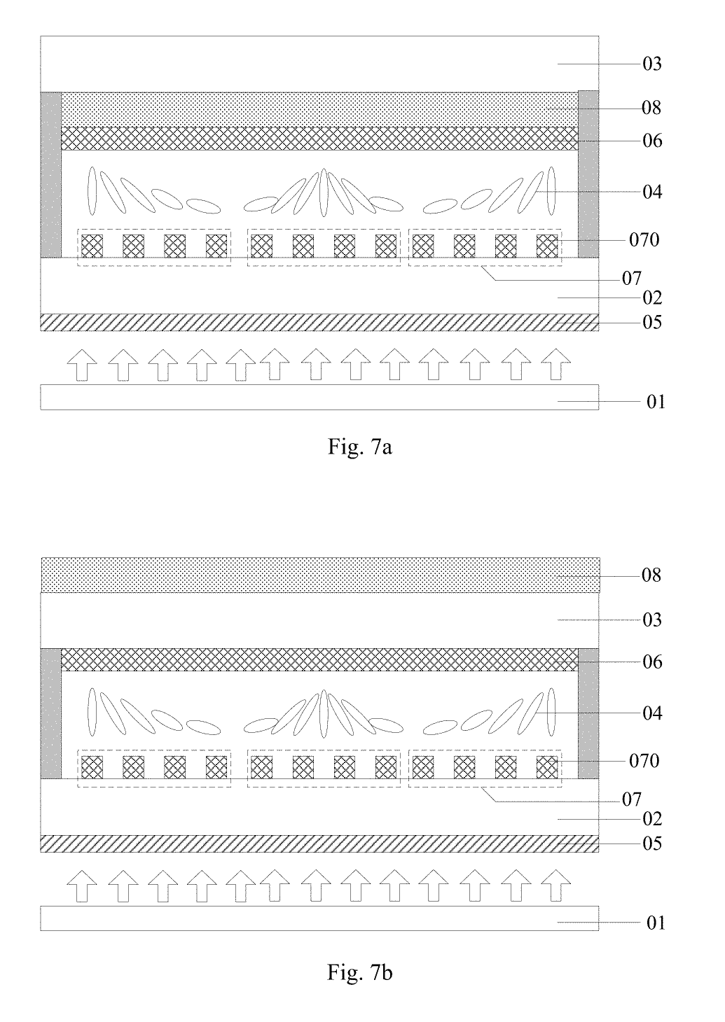

Further, to realize color display, in the liquid crystal display provided by the embodiment of the disclosure, as shown in FIG. 7a and FIG. 7b, the liquid crystal display further includes a color conversion layer 08 located on a side of the liquid crystal layer 04 departing from the lower substrate 02. The color conversion layer 08 is used for converting light passing through the liquid crystal layer 04 corresponding to the microprism structure into light of at least one color, and light emitted from the backlight 01 is converted into light of at least three colors after passing through the color conversion layer 08.

It should be noted that, in some embodiments, a light beam with a color corresponds to a sub-pixel in an existing liquid crystal display. Therefore, in the liquid crystal display provided by the embodiment of the disclosure, one microprism structure corresponds to at least one sub-pixel, and the liquid crystal display includes sub-pixels of at least three colors, such as red sub-pixel, blue sub-pixel, and green sub-pixel, which is not limited herein.

In certain exemplary embodiments of the liquid crystal display, one microprism structure corresponds to one sub-pixel. That is, the color conversion layer provides a light beam with only one color in a region corresponding to one microprism structure.

In an implementation, in the liquid crystal display provided by the embodiment of the disclosure, as shown in FIG. 7a, the color conversion layer 08 can be interposed between the upper substrate 03 and the lower substrate 02. Of course, the color conversion layer 08 can also be provided on the side of the upper substrate 03 departing from the liquid crystal layer 04, which is not limited herein.

Further, in the liquid crystal display provided by the embodiment of the disclosure, the color conversion layer 08 is a light splitting film or a color filter film including color filters of at least one color. Each color filter can correspond to one microprism structure, which is not limited herein.

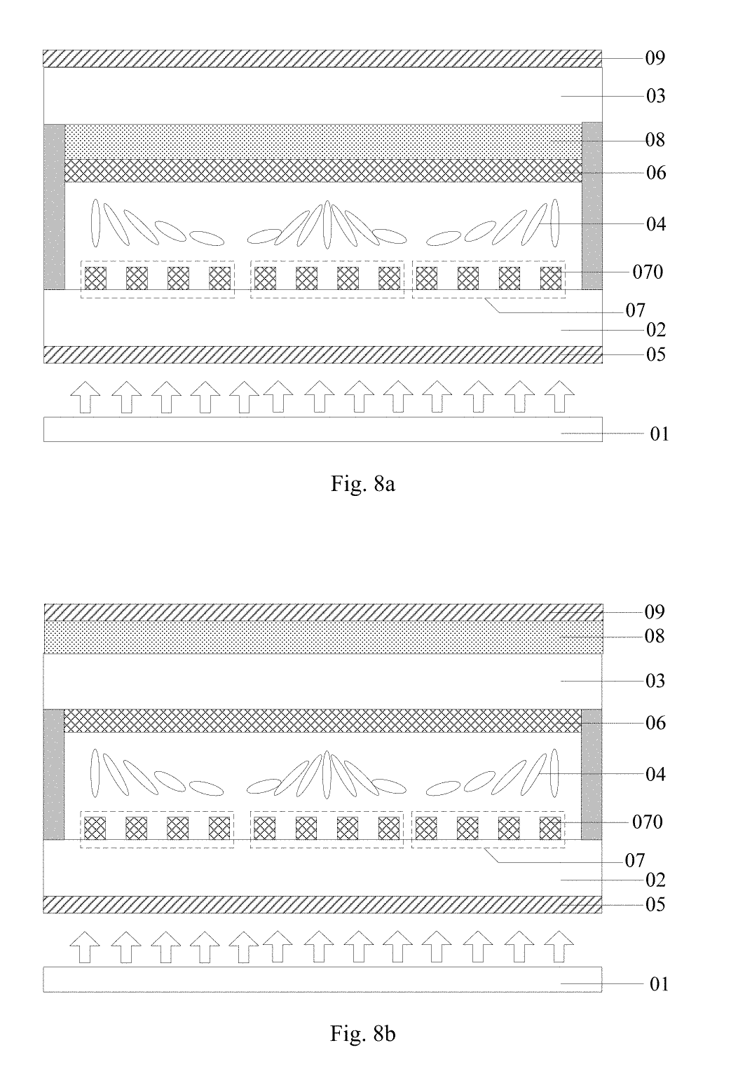

In certain exemplary embodiments of the liquid crystal display, as shown in FIG. 8a and FIG. 8b, the liquid crystal display further includes a second polarizer 09 located on a side of the upper substrate 03 departing from the liquid crystal layer 04. A polarization direction of the second polarizer 09 is parallel to a polarization direction of the first polarizer 08. In this way, the second polarizer 09 further linearly polarizes the light beam emitted from the liquid crystal display, thereby effectively improving the display effect.

Further, in the liquid crystal display provided by the embodiment of the disclosure, the preset viewing angle range can be fixed to a certain range, so that the control unit controls a ratio of energy distribution within the preset viewing angle range for light emitted from the microprism structure based on the image data. However, if the target human eye is beyond the preset viewing angle range, the image cannot be observed normally. Therefore, in certain exemplary embodiments, as shown in FIG. 1a and FIG. 1b, the liquid crystal display further includes a human eye tracking unit 120.

The human eye tracking unit 120 determines the preset viewing angle range by tracking a target human eye and transmits the determined preset viewing angle range to the control unit 110. The control unit 110 adjusts the voltage applied on the sub-electrodes of the electrode unit based on the preset viewing angle range.

In the context of the disclosure, the “control unit” and “human eye tracking unit” in the embodiments can be realized by a computer (e.g. personal computer) or a combination of a computer and a suitable sensor; the processing of these units can be realized e.g. by a processor in the computer.

Based on the same inventive concept, an embodiment of the present disclosure provides electronic equipment including the above mentioned liquid crystal display. The electronic equipment can be any product or component with display function, such as lighting equipment, mobile phone, tablet computer, TV, display, notebook computer, digital photo frame and navigator. The implementation of the electronic equipment can refer to the embodiments of the above mentioned liquid crystal display, which will not be repeated herein.

The embodiments of the present disclosure provide a liquid crystal display and electronic equipment. During displaying, the control unit applies a voltage between the sub-electrodes and the first transparent electrode based on an image data, so that liquid crystal molecules in the liquid crystal layer corresponding to the electrode unit are deflected to form a microprism structure. The microprism structure is adjusted by controlling the magnitude of the potential on the sub-electrodes of the electrode unit, thereby controlling a ratio of energy distribution within a preset viewing angle range for light emitted from the backlight and refracted by the microprism structure. Therefore, the light intensity within the preset viewing angle range can be controlled by the microprism structure, realizing gray scale display.

Apparently, the person skilled in the art may make various alterations and variations to the disclosure without departing the spirit and scope of the invention. As such, provided that these modifications and variations of the invention pertain to the scope of the claims of the disclosure and their equivalents, the disclosure is intended to embrace these alterations and variations.

1. A liquid crystal display comprising: a backlight, a lower substrate on a light exit side of the backlight, an upper substrate arranged opposite to the lower substrate, and a liquid crystal layer located between the upper substrate and the lower substrate; further comprising:
a first transparent electrode and a second transparent electrode respectively located on both sides of the liquid crystal layer, and a control unit for applying a voltage between the first transparent electrode and the second transparent electrode;
wherein the first transparent electrode is a planar electrode; the second transparent electrode comprises a plurality of electrode units, and each electrode unit comprises a plurality of sub-electrodes arranged in parallel and extending in a straight line;
and wherein during displaying, the control unit applies a voltage between the sub-electrodes and the first transparent electrode based on an image data, so that liquid crystal molecules in the liquid crystal layer corresponding to the electrode unit are deflected to form a microprism structure; the microprism structure is adjusted by controlling the magnitude of potential on the sub-electrodes of the electrode unit, thereby controlling a ratio of energy distribution within a preset viewing angle range for light emitted from the backlight and refracted by the microprism structure.

2. The liquid crystal display according to claim 1, wherein the first transparent electrode and the second transparent electrode are located between the upper substrate and the lower substrate.

3. The liquid crystal display according to claim 1, further comprising a color conversion layer located on a side of the liquid crystal layer departing from the lower substrate;
wherein the color conversion layer is used for converting light passing through the liquid crystal layer corresponding to the microprism structure into light of at least one color, and light emitted from the backlight is converted into light of at least three colors after passing through the color conversion layer.

4. The liquid crystal display according to claim 3, wherein the color conversion layer is a light splitting film or a color filter film.

5. The liquid crystal display according to claim 1, wherein light emitted from the backlight is collimated light or parallel light.

6. The liquid crystal display according to claim 1, further comprising a human eye tracking unit;
wherein the human eye tracking unit determines the preset viewing angle range by tracking a target human eye and transmits the determined preset viewing angle range to the control unit;
and wherein the control unit adjusts the magnitude of potential on the sub-electrodes of the electrode unit based on the preset viewing angle range.

7. The liquid crystal display according to claim 1, wherein the first transparent electrode is located on a side of the upper substrate facing the liquid crystal layer, and the second transparent electrode is located on a side of the lower substrate facing the liquid crystal layer;
alternatively, the second transparent electrode is located on a side of the upper substrate facing the liquid crystal layer, and the first transparent electrode is located on a side of the lower substrate facing the liquid crystal layer.

8. The liquid crystal display according to claim 1, wherein the greater an equivalent optical path of the microprism structure along a cell thickness of the liquid crystal display, the smaller a voltage difference applied on the transparent electrodes on both sides of the liquid crystal layer corresponding to the microprism structure.

9. The liquid crystal display according to claim 1, wherein the microprism structure is a triangular prism structure or a quadrilateral prism structure.

10. The liquid crystal display according to claim 1, wherein the sub-electrode is composed of at least one linear electrode or a plurality of punctate electrodes.

11. The liquid crystal display according to claim 1, further comprising a first polarizer located between the lower substrate and the backlight.

12. The liquid crystal display according to claim 11, further comprising a second polarizer located on a side of the upper substrate departing from the liquid crystal layer; wherein a polarization direction of the second polarizer is parallel to a polarization direction of the first polarizer.

13. Electronic equipment comprising the liquid crystal display according to claim 1.

14. The electronic equipment according to claim 13, wherein the first transparent electrode and the second transparent electrode are located between the upper substrate and the lower substrate.

15. The electronic equipment according to claim 13, further comprising a color conversion layer located on a side of the liquid crystal layer departing from the lower substrate;
wherein the color conversion layer is used for converting light passing through the liquid crystal layer corresponding to the microprism structure into light of at least one color, and light emitted from the backlight is converted into light of at least three colors after passing through the color conversion layer.

16. The electronic equipment according to claim 15, wherein the color conversion layer is a light splitting film or a color filter film.

17. The electronic equipment according to claim 13, wherein light emitted from the backlight is collimated light or parallel light.

18. The electronic equipment according to claim 13, further comprising a human eye tracking unit;
wherein the human eye tracking unit determines the preset viewing angle range by tracking a target human eye and transmits the determined preset viewing angle range to the control unit;
and wherein the control unit adjusts the magnitude of potential on the sub-electrodes of the electrode unit based on the preset viewing angle range.

19. The electronic equipment according to claim 13, wherein the first transparent electrode is located on a side of the upper substrate facing the liquid crystal layer, and the second transparent electrode is located on a side of the lower substrate facing the liquid crystal layer;
alternatively, the second transparent electrode is located on a side of the upper substrate facing the liquid crystal layer, and the first transparent electrode is located on a side of the lower substrate facing the liquid crystal layer.

20. The electronic equipment according to claim 13, wherein the greater an equivalent optical path of the microprism structure along a cell thickness of the liquid crystal display, the smaller a voltage difference applied on the transparent electrodes on both sides of the liquid crystal layer corresponding to the microprism structure.
